(19) United States
(12) Patent Application Publication
(10) Pub. No.: US 2017/0239732 A1
(43) Pub. Date: Aug. 24, 2017

(54) CUTTING TOOL

(71) Applicant: MetalWerks PMD, Inc., Aliquippa, PA (US)

(72) Inventor: Christopher E. Bennett, Freedom, PA (US)

(21) Appl. No.: 15/434,691

(22) Filed: Feb. 16, 2017

Related U.S. Application Data
(60) Provisional application No. 62/297,273, filed on Feb. 19, 2016.

(51) Int. Cl. B23B 27/08

(52) U.S. Cl. CPC B23B 27/08

(57) ABSTRACT

Disclosed is a tool that may be configured for performing work on a workpiece. Embodiments of the tool can be configured as a body to be used with a rotatable drive. Some embodiments can include an insert that may be secured within a chamber portion of the tool. The insert may be configured to perform a certain type of work. Some embodiments can include a port. The port may facilitate ingress to and/or egress from the chamber portion. The port may allow for interchangeability of inserts. The port may allow for discharge of work by-product.

### CROSS-REFERENCE TO RELATED APPLICATIONS

The present application claims priority to U.S. Provisional Patent Application No. 62/297,273 filed on Feb. 19, 2016, the entire contents of which is incorporated herein by reference.

### FIELD OF THE INVENTION

The present application relates to tools for deburring ends of a tube or bar. Embodiments of the tool can be configured as a body with an insert that may be used with a rotatable drive, where the rotatable drive can cause the workpiece and/or the tool to rotate so that the insert can perform work on the workpiece.

### BACKGROUND OF THE INVENTION

When metal tubes or bars are cut, cast, or molded, burs are often formed on the edge of the tube or bar that must be removed. Sometimes, it is desirable to chamfer the edges. Conventional systems and methods for de-burring and chamfering can be limited. In addition, some conventional finishing techniques may lack the ability to maintain a clean and/or controlled working surface (e.g., internal cutting surface). Some conventional finishing techniques inadequately remove machining chips or other work by-product that may be generated during working. These can bind and/or damage the workpiece being worked upon.

### SUMMARY OF THE INVENTION

I provide a tool having carbide inserts that is particularly useful for de-burring and chamfering metal tubes and bars.

Embodiments can include a tool that may be configured for performing work on a workpiece. Embodiments of the tool can be configured as a body to be used with a rotatable drive. For example, the body may be connected to the rotatable drive so that the rotatable drive can cause the tool to rotate. Some embodiments can include a rotatable drive adapted to cause the workpiece to rotate in addition, or in the alternative, to causing the tool to rotate. In some embodiments, the workpiece can be inserted through a mouth portion of the body. Rotation of the tool and/or workpiece may then be used to perform work on a workpiece.

Some embodiments can include an insert that may be secured within a chamber portion of the tool. The insert may be configured to perform a certain type of work. For example, as the rotatable drive causes the tool and/or workpiece to rotate, the insert can make contact with at least a portion of the workpiece. Rotating the tool and/or workpiece while the insert makes physical contact with the workpiece can result in work being performed on the workpiece. The work can be a type of finishing. This can include cutting, turning, chamfering, de-burring, grooving, knurling, grinding, buffing, burnishing, polishing, etc. Some embodiments can include more than one insert. Any one insert can be the same as or different from another insert. Any one insert can be configured to perform the same or different type of work as another insert.

In some embodiments, the body portion of the tool can include a port. The port can facilitate ingress to and/or egress from the chamber portion. The port may allow for interchangeability and/or replacement of inserts. The port may allow for discharge of work by-product. For example, as work is being performed on the workpiece, work by-product (e.g., swarf, chips, turnings, filings, shavings, etc.) can be generated. The work by-product may be discharged through the port.

Some embodiments can include a pin. The pin can be used to prevent a distal end of the workpiece from making contact with a portion of the body. The pin may be freely rotatable relative to the body. This can be done to prevent damage and/or unwanted work from occurring on a portion of the workpiece.

At least one embodiment can enable a low cost, high quality method to work (e.g., debur) the ends of a workpiece (e.g., tube, bar, etc.) that may demand very precise and close tolerance work. Some embodiments can enable working a workpiece without scratching or damaging a surface of the workpiece, including a distal end of the workpiece. At least one embodiment may provide for a body (e.g., a tool holder) with internal inserts and cutters that can be mounted into any rotatable drive (e.g., convenient drill or drive mechanism) for the purposes of working (e.g., de-burring, chamfering, etc.) the workpiece.

In some embodiments, the tool can be configured to perform cutting, such as turning, on a round outside diameter surface while the round surface is constrained within a fixed or rotating tool. In some embodiments, the method can provide an option for the tool to be used either in the rotating configuration or in the fixed configuration. With the tool in the fixed configuration, the workpiece may be caused to rotate.

In at least one embodiment, the tool may be made into an elongated member with at least one port (e.g., window) for inserts and cutters, those allowing for various applications like external cutting, grooving, knurling, and/or similar applications. For example, embodiments of the tool can include use of internal cutting inserts that can be removed directly from the outside of the tool. This can provide the potential to open up a number of cutting applications that previously were limited.

An embodiment of the tool can include a body. The body can include an elongated member with a workpiece aperture formed therein. The body may include a first end and a second end. The second end can be configured to be held by a securement means. The first end can be configured to receive at least a portion of a workpiece. The tool can further include at least one insert. The at least one insert may be located within the workpiece aperture. The at least one insert can be configured to perform work on the workpiece while at least one of the workpiece and the tool is rotated.

An embodiment of the tool can include a body. The body can include an elongated member having a first end and a second end. The body may further include an open workpiece chamber located between the first end and the second end. The open workpiece chamber may have a chamber wall and a workpiece aperture extending from the first end to the open chamber. The workpiece aperture may be sized to receive a workpiece. The tool may further include at least one insert attached to the chamber wall. The at least one insert may be positioned to engage the workpiece that is within the open workpiece chamber.

In some embodiments, the second end and the first end can be aligned along a longitudinal axis. The rotation of at least one of the workpiece and the tool can be about the longitudinal axis. In some embodiments, the tool and the workpiece may be translatable relative to each other. This may be along the longitudinal axis.

In some embodiments, rotation of at least one of the workpiece and the tool can be caused by a rotatable drive. Some embodiments can include a cutting system. The cutting system may include the tool and rotatable drive.

In some embodiments, the work may be at least one of cutting, turning, chamfering, de-burring, grooving, knurling, grinding, buffing, burnishing, and polishing. In some embodiments, the first end can include a mouth into which a buffer ring is disposed. In some embodiments, the at least one insert can be configured to perform work on the workpiece while the tool and the workpiece are translated relative to each other along the longitudinal axis.

In some embodiments, at least a portion of the workpiece aperture can form a chamber into which a distal end of the workpiece is capable of being seated. The at least one insert may be configured to make contact with an outer surface of the workpiece so as to prevent the outer surface of the workpiece from making contact with a surface of the chamber.

In some embodiments, at least a portion of the workpiece aperture can form a chamber into which a distal end of the workpiece is seated. The at least one insert can be configured to make contact with an outer surface of the workpiece so as to prevent the outer surface of the workpiece from making contact with a surface of the chamber. The first end can include a mouth into which a buffer ring may be disposed. The buffer ring can be configured to make contact with a portion of the outer surface of the workpiece to hold the workpiece approximately parallel to the longitudinal axis.

In some embodiments, the body can further include a sidewall and at least one port formed within the sidewall. In some embodiments, the at least one port can be configured to facilitate discharge of work by-product. In some embodiments, the tool can be configured to automatically discharge the work by-product. In some embodiments, the body can further include at least one through-hole.

In some embodiments, the body can further include sidewalls conjoined with a stop. The second end may further include a pin configured to move along the longitudinal axis. The pin may be configured to prevent a distal end of the workpiece from making contact with the stop. In some embodiments, the pin can be freely rotatable about the longitudinal axis. In some embodiments, the tool can include a spring configured to bias the pin in a direction along the longitudinal axis.

An embodiment of the tool can include a body. The body may include an elongated member with a workpiece aperture formed therein. The body may have a first end and a second end. The second end can be configured to be held by a securement means. The first end can be configured to receive at least a portion of a workpiece. The tool can further include at least one connector located within the workpiece aperture. The tool can further include at least one insert removably inserted into the at least one connector. The at least one insert may be configured to perform work on the workpiece while at least one of the workpiece and the tool is rotated. A port may be formed into a portion of the body. In some embodiments, the tool can include a plurality of inserts. Each insert of the plurality of inserts can be configured to perform a type of work that is different from a type of work of each other insert.

A method of performing work on a workpiece can include inserting an insert configured to perform work on a workpiece into a connector of a tool. The tool may include a body having a first end and a second end. The first end can have a workpiece aperture. The connector can be formed within the workpiece aperture. The workpiece aperture may be aligned along a longitudinal axis of the tool. The method may further include inserting a portion of a workpiece into the workpiece aperture. This may include inserting the workpiece so as to cause the insert to make contact with a surface of the workpiece. The method can further include causing at least one of the workpiece and the tool to at least one of rotate about the longitudinal axis and move along the longitudinal axis to facilitate performing the work on the workpiece.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1 is perspective view of a present preferred embodiment of the cutting tool.

FIG. 2A is a front view of an embodiment of FIG. 1 looking into the mouth of the body.

FIG. 2B is a cross sectional view of an embodiment of the tool taken along the A-A line in FIG. 1.

FIG. 3 is a side view of a present preferred embodiment of an insert for the cutting tool shown in FIG. 1.

FIG. 4A is a side view of an exemplary workpiece having a region of reduced cross sectional diameter via turning work that may be performed by the tool, and FIG. 4B is a side view of an exemplary workpiece having two regions of reduced cross sectional diameter via turning work that may be performed by the tool.

FIG. 5 is a perspective view of the embodiment shown in FIG. 1.

FIG. 6 is another perspective view of the embodiment shown in FIG. 1.

FIG. 7 is a side view of the embodiment shown in FIG. 1.

FIG. 8 is partial view of an embodiment of the body, showing a cross sectional view of the second end of the body, taken along the A-A line in 1.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of the present invention. The scope of the present invention is not limited by this description.

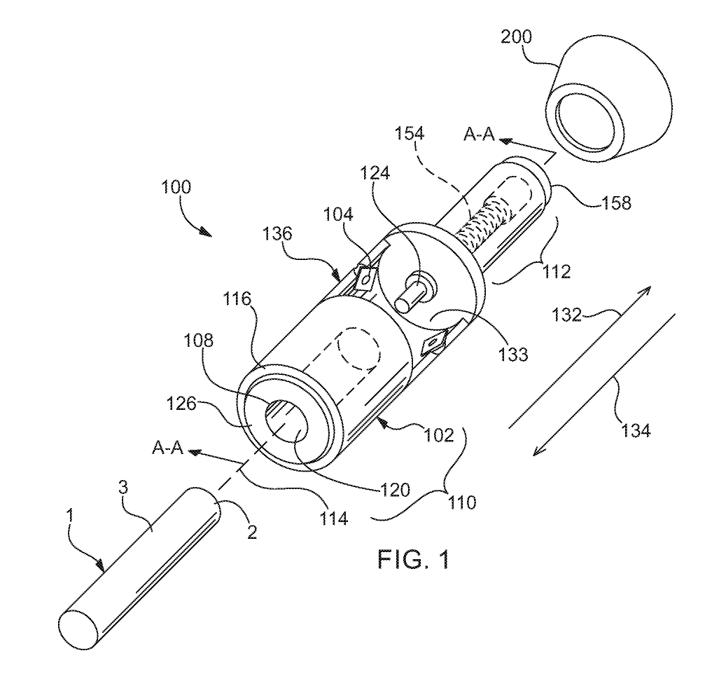

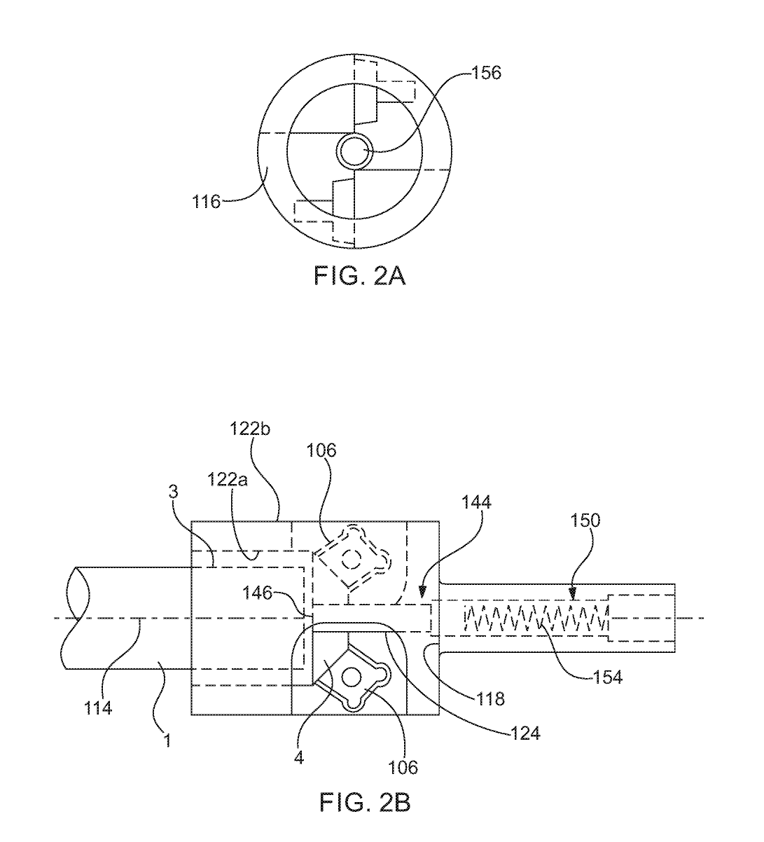

Referring to FIGS. 1-2B, a present preferred embodiment of the cutting tool 100 can include a body 102. The body 102 may include an elongated member having a first end 110 and a second end 112. The body 102 may further include an open workpiece chamber 133 located between the first end 110 and the second end 112. The open workpiece chamber 133 can have a chamber wall. The body 102 may further include a workpiece aperture 120 extending from the first end 110 to the open chamber 133. The workpiece aperture 102 may be sized to receive a workpiece 1. In some embodiments, at least one insert 106 may be attached to the chamber wall and positioned to engage the workpiece 1 that is within the open workpiece chamber 133.

In some embodiments, the body 102 can include a connector 104. The connector 104 can be configured to secure an insert 106. The insert 106 can be configured to perform work on a workpiece 1. The work can be a type of finishing. This can include cutting, turning, chamfering, de-burring, grooving, knurling, grinding, buffing, burnishing, polishing, etc. In some embodiments, the body 102 can be configured to engage to a rotatable drive 200 (e.g., a portable drill, a handheld drill, etc.). The rotatable drive 200 can also be part of an automatic machine tool (e.g., a lathe). For example, the body 102 may be configured to be part of a cartridge of tools for the automatic machine tool. In some embodiments, the rotatable drive 200 can be configured to engage the workpiece 1. A portion of the workpiece 1 may be inserted into a mouth 108 of the body 102. The rotatable drive can cause the tool 100 and/or the workpiece 1 to rotate. Rotating the tool 100 and/or the workpiece 1 can cause the insert 106 to make contact with at least a portion of the workpiece 1. Rotating the tool 100 and/or workpiece 1 can further cause the insert 106 to perform work on the workpiece 1.

The body 102 can be fabricated from a rigid material, such as tool steel or other metal. The body 102 can include a first end 110. The body 102 can include a second end 112. The first end 110 may include the mouth 108. The mouth 108 may oppose the second end 112 such that the second end 112 and the mouth 108 define a longitudinal axis 114. The second end 112 can be configured to engage with the rotatable drive 200. The rotatable drive 200 may be a drill, rotating motor, etc. The rotatable drive 200 can be electrically driven, air driven, etc. The second end 112 can be configured to be received by a securement means. In some embodiments, the securement means may be part of the rotatable drive 200. For example, the second end 112 may be configured to be received by a chuck (e.g., a securement means) of a drill (e.g., a rotatable drive 200). In some embodiments, the second end 112 can be configured as a shank extending from a portion of the body 102. The shank may extend from the body 102 along the longitudinal axis 114. The shank may have a cross section that is cylindrical, cubic, hexagonal, etc. A surface of the shank may be smooth, textured, toothed, etc. The cross section and/or surface texture of the shank may be selected to provide a better engagement with the securement means.

The first end 110 can include an elongated body with sidewalls 116. The sidewalls 116 may be conjoined with a stop 118. The mouth 108 may be formed by an opening located at an end of the body 102. The mouth 108 may be positioned to be opposite the stop 118 and in line with the stop 118 along the longitudinal axis 114. In some embodiments, the mouth 108, the stop 118, and the second end 112 can all lie within the longitudinal axis 114. The body may further include a workpiece aperture 120. The workpiece aperture 120 may extend from the mouth 108 to the stop 118. The workpiece aperture 120 may define a chamber 133 within the body 102. The first end 110 can be configured to receive at least a portion of the workpiece 1. For example, the workpiece 1 may be inserted through the mouth 108 to be received by the workpiece aperture 120. This may include at least a portion of the workpiece 1 lying within the chamber 133 defined by the workpiece aperture 120. In some embodiments, the workpiece 1 may be inserted through the mouth 108 and into the workpiece aperture 120 until a portion of the workpiece 1 abuts the stop 118. For example, the workpiece 1 may be inserted through the mouth 108 and into the workpiece aperture 120 until a distal end 2 of the workpiece 1 abuts the stop 118. As will be explained later, some embodiments can include an insert 106. Some embodiments of the tool 100 can be configured such that the distal end 2 of the workpiece 1 abuts the insert 106, thereby preventing the distal end 2 of the workpiece 1 from making contact with the stop 118. (See FIG. 2B).

Depending on the work to be performed, the workpiece 1 may be inserted into the body 102 so that the insert 106 performs work on the workpiece 1 as the workpiece 1 and/or the tool 100 are moved relative to each other (e.g., translatable relative to each other) along the longitudinal axis 114. This can include performing work on the workpiece 1 as the tool 100 and/or workpiece are rotated or not rotated. Some embodiments can be configured to allow the distal end 2 of the workpiece 1 to move towards the stop 118 without making contact with the stop 118. This can be achieved by the workpiece 1 abutting the insert 106, whereby the insert prevents any further movement of the workpiece 1 towards the stop 118. As will be explained later, this can also be achieved via use of a pin 124. In other embodiments, the distal end 2 of the workpiece 1 can be moved towards the stop 118 until the distal end 2 of the workpiece 1 abuts the stop 118.

The first end 110 can include an outer surface 3. A cross section of the first end 110 at the outer surface 3 can be cylindrical, cubic, hexagonal, etc. The first end 110 of the body can include an inner surface 122a and an outer surface 122b. It is contemplated for the cross section of the first end 110 at the inner surface 122a to be cylindrical, but other shapes such as cubic, hexagonal, etc. can be used. The chamber 133 formed by the workpiece aperture 120 can define an inner diameter ID spanning from subtending ends of inner surfaces 122a of the sidewall 116. The inner surfaces 122a of the sidewall 116 within the chamber 133 can form a chamber wall. The distance spanning from subtending points on the outer surface 122b can define an outer diameter OD. It is contemplated for the inner diameter ID to be greater than a cross sectional diameter of the workpiece 1, or at least the distal end 2 of the workpiece 1, that the body 102 is intended to receive. For example, if the cross sectional diameter of a distal end 2 of a workpiece is 10 mm, the inner diameter ID may be greater than 10 mm. It is contemplated for the tool 100 to be used for workpieces 1 having distal ends 2 with cross sectional diameters ranging from 1 mm to 1,000 mm. However, the tool 100 can be configured to perform work on workpieces 1 with any length of cross sectional diameter. It is contemplated that for larger workpieces 1, the workpiece 1 and/or tool 100 may be held in fixed equipment suitable to the application. For example, the workpiece 1 may be held in a securement means of a lathe while the tool 100 is attached to a jig or some other mechanism that is connected to a rotatable drive 200 of the lathe.

A sidewall 116 can include a connector 104. The connector 104 can be configured to secure an insert 106 to the body 102. This can include removably securing or permanently securing the insert 106 to the body 102. In some embodiments, the connector 104 can be configured as a recess to receive and temporarily retain an insert 106. For example, the connector 104 can be a socket formed within the sidewall 116 to hold an insert 106 in place. In some embodiments, the connector 104 can be located on an inner surface 122a of the sidewall 116. For example, securing an insert 106 within the connector 104 can allow the insert 106 to be exposed to the chamber 133 formed by the workpiece aperture 120.

There can be more than one connector 104. Any connector 104 can be located at any location on the sidewall 116. It is contemplated for the insert 106 to perform work on the workpiece 1, and thus placement of the connector 104 may be dictated by the type of work expected to be performed. For example, the insert 106 may be used to form a groove in the workpiece 1 at a certain distance from the distal end 2 of the workpiece 1. In embodiments where the distal end 2 of the workpiece 1 is caused to abut against, or almost abut against, the stop 118, the distance along the longitudinal axis 114 from the stop 118 to the connector 104 can be used to determine where the groove may be formed on the workpiece 1. For instance, a distance from the stop 118 to the connector 104 can be X. If the workpiece 1 is inserted into the mouth 108 and through the workpiece aperture 120 so that its distal end 2 abuts, or almost abuts, the stop 118, the connector 104 can be located at a distance X from the distal end 2 of the workpiece 1. This may cause the insert 106 (when one is secured to the connector 104) to also be located at a distance X from the distal end 2 of the workpiece 1. Thus, when the tool 100 is used to perform work on the workpiece 1, the work can be performed at the distance X from the distal end 2 of the workpiece 1. For example, a groove can be formed in the outer surface 3 of the workpiece 1 at a distance X from the distal end 2 of the workpiece 1 by inserting the workpiece 1 into an embodiment of the tool 100 so that the distal end 2 abuts, or almost abuts, the stop 118 and where the distance from the stop 118 to the connector 104 is X. The tool 100, having an insert 106 secured to the connector 104, and/or the workpiece 1 can be caused to rotate. This can cause the insert 106 to generate a groove in the outer surface 3 of the workpiece 1 at the distance X from the distal end 2 of the workpiece 1.

As will be explained in detail later, some embodiments can include a pin 124. The pin 124 can be configured to allow the distal end 2 to almost abut the stop 118. For example, the pin 124 can be spring loaded to allow the workpiece 1 to move towards the stop 118 but cease the movement when the pin 124 is flush with, or approximately flush with, the stop 118. This may allow the distal end 2 to almost come into contact with the stop 118.

In addition to being located at any distance along the longitudinal axis 114, any connector 104 can be located at any radial location along the inner surface 122a. A radial location can be defined as a position point along a path following the inner surface 122a at a given position along the longitudinal axis 114.

Some embodiments can include a plurality of connectors 104. Any two or more connectors 104 can be located at a same or different distance along the longitudinal axis 114. For example, a first connector 104 can be located at a distance X from the stop 118. A second connector 104 can be located at a distance J from the stop, where J can be greater than or less than X. Any two re more connectors 104 can be located at a same or a different radial location along the inner surface 122a. FIG. 2A shows a first connector 106 located at a 12 o'clock position and a second connector 106 located at a 6 o'clock position. As another example, each of a first connector 104, a second connector 104, a third connector 104, and a fourth connector 104 can be located at a distance X from the stop 118 along the longitudinal axis 114. The first connector 104 can be located at a 12 o'clock radial position. The second connector 104 can be located at a 3 o'clock radial position. The third connector 104 can be located at a 6 o'clock radial position. The fourth connector 104 can be located at a 9 o'clock radial position. More or less connectors 104 and different longitudinal and/or radial positions can be used.

A connector 104 can be configured to secure an insert 106 so that the insert 106 makes contact with an outer surface 3 of the workpiece 1. This can include causing the insert 106 to make contact with the workpiece 1 without the workpiece 1 making contact with the inner surface 122a of the sidewall 116. In some embodiments, at least two connectors 104 can be positioned at different radial locations so as to cause the inserts 106 secured therein to both make contact with an outer surface of the workpiece 1. This can include preventing the outer surface of workpiece 1 from making contact with the inner surface 122a of the sidewall 116. For example, a first connector 104 can be positioned so as to subtend a second connector 104 (e.g., be 180-degrees from each other). The workpiece 1 may be bound by the inserts 106 of the 180-degree separated connectors 104 so as to prevent the outer surface 3 of the workpiece 1 from making contact with the inner surface 122a of the sidewall 116. More than two connectors 104 can be used for this purpose. Furthermore, other radial locations and degrees of separation can be used for this purpose.

Alternatively, a connector 104 can be configured to secure an insert 106 so that the insert 106 makes contact with the outer surface 3 of the workpiece 1, where the outer surface 3 near the distal end 2 of the workpiece 1 does not make contact with the inner surface 122a of the sidewall 116 but the outer surface 3 of the workpiece 1 is capable of making contact with a portion of the inner surface 122a at or near the mouth 108. This can allow the workpiece 1 to be held approximately parallel to the longitudinal axis 114. In some embodiments, the mouth 108 of the body 102 can include a buffer ring 126. The buffer ring 126 can be an annular element configured to fit within the chamber 133. The buffer ring 126 can have an opening that may be configured to allow the workpiece 1 to be slid therethrough. The buffer ring 126 may be configured such that the outer surface 3 of the workpiece 1 at or near the mouth 108 can make contact with the buffer ring 126. The contact with the buffer ring 126 can allow the workpiece 1 to be held approximately parallel to the longitudinal axis 114. The buffer ring 126 can be fabricated from a material that is softer than that of the workpiece 1. The buffer ring 126 may be replaceable. In some embodiments, the buffer ring 126 can be sacrificial. In some embodiments, the buffer ring 126 can include a bearing race. This may allow the buffer ring 126 to rotate independently and freely with respect to the tool.

As the tool 100 and/or workpiece 1 is caused to rotate and/or caused to move along the longitudinal axis 114, the outer surface of the workpiece 1 at or near the mouth 108 can make contact with the inner surface 122a and/or the buffer ring 126. The workpiece 1 may be bound by the inserts 106 so as to prevent an outer surface 3 of the distal end 2 of the workpiece 1 from making contact with the inner surface 122a of the sidewall 116 at or near the stop 118 while the tool 100 and/or workpiece 1 is caused to rotate and/or caused to move along the longitudinal axis 114. In some embodiments, the workpiece 1 may be bound by the inner surface 122a at or near the mouth 108 and/or the buffer ring 126 so as to hold the workpiece 1 approximately parallel to the longitudinal axis 114 while the tool 100 and/or workpiece 1 is caused to rotate and/or caused to move along the longitudinal axis 114.

Some connectors 104 can secure an insert 106 so that the insert 106 forms an angle that is normal, oblique, or acute to an outer surface 3 of the workpiece 1. This can include configuring the connector 104 so that is secures an insert 106 so that it forms an angle that is normal, oblique, or acute to the longitudinal axis 114.

Embodiments of the tool 100 with a plurality of connectors 104 can be used with each connector 104 having an insert 106 secured therein, with only some connectors 104 having an insert 106 secured therein, or only one connector 104 having an insert 106 secured therein.

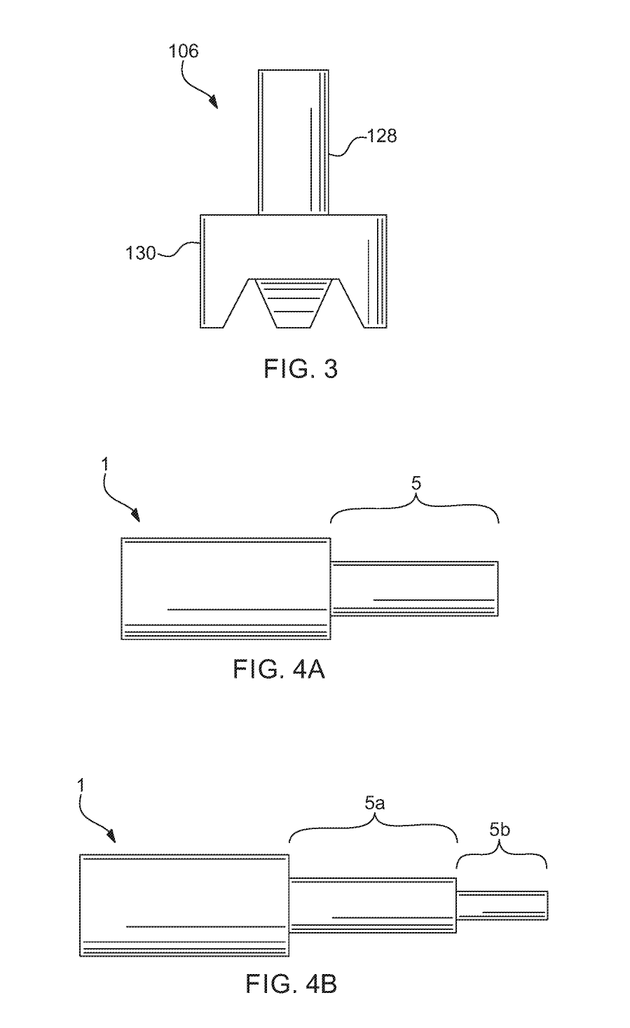

Referring to FIG. 3, in some embodiments, the insert 106 can be configured as a shaft 128 having a head 130. The shaft 128 can be configured to engage the connector 104. This can include engaging the connector 104 so as to facilitate being secured therein. For example, the connector 104 can be configured as a socket and the shaft 128 may be shaped to form an interference fit within the connector 104. It is contemplated for the insert 106 to be configured such that once secured within the connector 104, at least a portion of the head 130 is capable of protruding radially inward from an inner surface 122a of the sidewall 116. This may facilitate allowing the head 130 to make contact with the workpiece 1 once the workpiece 1 is inserted within the tool 100. The head 130 can be configured to perform work. The work can be a type of finishing. This can include cutting, turning, chamfering, de-burring, grooving, knurling, grinding, buffing, burnishing, polishing, etc. It is contemplated for the work to be performed by the head 130 by making physical contact with the workpiece 1. For example, the work can be performed through abrasion, friction, mechanical work, etc. The type of work to be performed may dictate the configuration of the head 130. For instance, if the insert 106 is to be used for cutting, the head may be configured as a cutting bit. If the insert 106 is to be used for grinding, the head 130 may be configured as a grinding bit. If the insert 106 is to be used for polishing, the head 130 may be configured as a polishing head. Some examples of insert heads 130 can be carbide cutters, diamond tips, brass brushes, etc.

The workpiece 1 may be a billet, a pipe, a rail, a rod, a bar, a tube, an engine part, piece of hardware, etc. The workpiece 1 may include metal, wood, ceramic, plastic, polycarbonate, etc. The material and/or configuration of the head 130 may be selected based on the type of material of the workpiece 1 and/or the type of work to be performed on the workpiece 1.

As noted above, the connector 104 may be configured to secure an insert 106 so that the insert 106 forms an angle that can be normal, oblique, or acute to the longitudinal axis 114. In addition, or in the alternative, the head 130 can be angled with respect to the shaft 128 so that the head 130 can form an angle that is normal, oblique, or acute to the longitudinal axis 114. Causing the insert 106 and/or the head 130 of the insert 106 to form an angle that is normal, oblique, or acute to the longitudinal axis 114 can be done to cause the insert 106 and/or the head 130 of the insert 106 to form an angle that is normal, oblique, or acute to an outer surface of the workpiece 1. This may be done to facilitate performing a type of work.

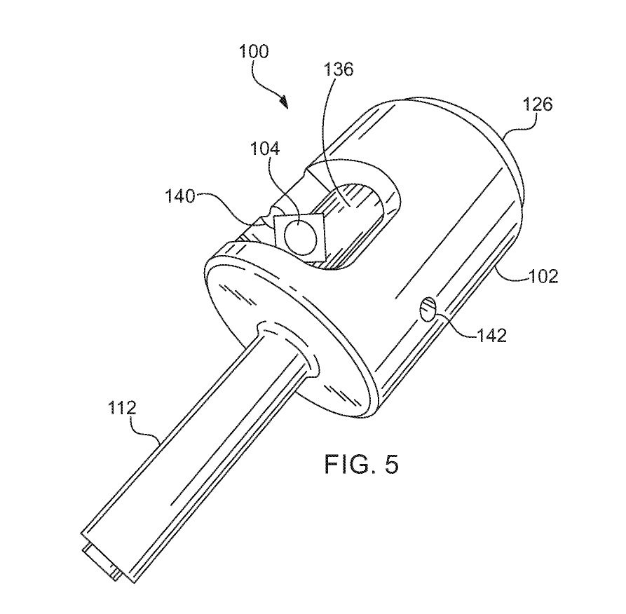

Additionally, or in the alternative, the body 102 may be machined to receive and hold a different degree insert 106, such as a 60-degree, 45-degree, or other degree insert 106. In some embodiments, the inner and/or outer surfaces 122a, 122b of the sidewalls 116 can be modified to accommodate holding an insert 106 at a certain angle with respect to the longitudinal axis 114. For example, FIG. 5 shows the inner surface 122a having a flat portion, where the insert 104 is located, that is parallel to the longitudinal axis 114. With inserts 104 having different degrees, the inner surface 122a may be machined so that the flat portion is not parallel to the longitudinal axis 114 (e.g., so that the flat portion forms an oblique or acute angle to the longitudinal axis 114). In addition, the portion where the insert 106 is located need not be flat. Other geometric shapes and surface contours can be used.

For instance, the tool 100 may be used to generate a chamfer at a distal end 2 of the workpiece 1. (See FIG. 2). One way to achieve this is to have at least the head 130 portion of the insert 106 be at an angle that is not normal (e.g., an acute or oblique angle) to the outer surface of the workpiece 1 so as to form a chamfer angle. For chamfering, the head 130 may be configured for cutting the workpiece 1. The workpiece 1 may be inserted through the mouth 108 and into the workpiece aperture 120. This may include inserting the workpiece 1 until a distal end 2 of the workpiece 1 abuts the stop 118 and/or pin 124. The insert 106 can be positioned so that it makes contact with an outer surface 3 of the workpiece 1 at or near the distal end 2 of the workpiece 1 as the distal end 2 of the workpiece 1 abuts the stop 118 and/or pin 124. Alternatively, the insert 106 can be positioned so that it makes contact with an outer surface 3 of the workpiece 1 at or near the distal end 2 of the workpiece 1, preventing the distal end 2 of the workpiece 1 from making contact with the stop 118 and/or pin 124. The tool 100 and/or workpiece 1 may then be caused to rotate via the rotatable drive 200. This can cause the insert 106 to cut the workpiece 1 at or near the distal end 2 of the workpiece 1 at the chamfer angle.

As another example, the head 130 of the insert 106 may be at any angle, including an angle that is normal to the outer surface of the workpiece 1. The workpiece 1 may be inserted through the mouth 108 and into the workpiece aperture 120. The insert 106 can be positioned so that it makes contact with an outer surface 3 of the workpiece 1 at the distal end 2 of the workpiece 1. The insert 106 can be configured so that it can remove a portion of the workpiece 1 at the outer surface 3. The tool 100 and/or workpiece 1 may then be caused to rotate via the rotatable drive 200. The workpiece 1 and/or tool 100 may be caused to move along the longitudinal axis 114. For example, the workpiece 1 may be caused to move in the rearward direction 132 and/or the tool 100 may be moved in the forward direction 134. This can cause the insert 106 to cut the workpiece 1 at the distal end 2 of the workpiece 1 to remove a corner 4 of the workpiece 130. The workpiece 1 can be moved in the rearward direction 132 until a desired portion of the corner 4 is removed, thereby forming the chamfer cut.

Referring to FIGS. 4A-4B, as another example, the tool 100 may be used for turning the workpiece 1 at or near the distal end 2. One way to achieve this is for at least the head 130 portion of the insert 106 to be at an angle that is normal to the outer surface 3 of the workpiece 1. However, other angles can be used while performing turning. For turning, the head 130 may be configured for cutting the workpiece 1. The workpiece 1 may be inserted through the mouth 108 and into the workpiece aperture 120. The insert 106 can be positioned so that it makes contact with an outer surface 3 of the workpiece 1 at or near the distal end 2 of the workpiece 1, preventing the distal end 2 of the workpiece 1 from making contact with the stop 118 and/or pin 124. This can include making contact with a corner 4 of the workpiece 1. The tool 100 and/or workpiece 1 may then be caused to rotate via the rotatable drive 200. This can cause the insert 106 to cut the workpiece 1 at or near the distal end 2 of the workpiece 1. As the tool 100 and/or workpiece 1 is caused to rotate, the workpiece 1 and/or the tool 100 can be caused to move along the longitudinal axis 114. This can include causing the workpiece 1 to move in a rearward direction 132 and/or causing the tool 100 to move in a forward direction 134. As the workpiece 1 and/or the tool 100 moves along the longitudinal axis 114, the insert 106 can continue to work on (e.g., cut) the workpiece 1. Allowing the insert 106 to work on the workpiece 1 as the workpiece 1 and/or tool 100 is moved along the longitudinal axis 114 can be done to reduce the cross sectional diameter of the workpiece 1 at and/or near the distal end 2 of the workpiece 1. This may be done to generate a region 5 at and/or near the distal end 2 of the workpiece 1 with a cross sectional diameter that is reduced with respect to the cross sectional diameter of another portion of the workpiece 1, as shown in FIG. 4A. For example, the workpiece 1 and/or the tool 100 can be moved along the longitudinal axis 114 until the distal end 2 of the workpiece 1 abuts the stop 118, preventing any further movement of the workpiece 1 in the rearward direction 132 and/or any further movement of the tool 100 in the forward direction 134. In some embodiments, the workpiece 1 and/or the tool 100 can be moved along the longitudinal axis 114 until the pin 124 arrests any further movement of the workpiece 1 in the rearward direction 132 and/or arrests any further movement of the tool 100 in the forward direction 134. This may generate a region 5 of reduced cross sectional diameter, where a length of the region can correspond to a distance from the insert 106 to the stop 118 and/or pin 124. The reduction of cross sectional diameter may correspond to the distance the head 130 extends radially inward from the inner surface 122a.

Some embodiments can include a set of inserts 106, each insert 106 having a different shaft-length, head-configuration, shaft-head angle, etc. For example, a set may include a first insert 106 having a head 130 configured for cutting, a second insert 106 having a head 130 configured for de-burring, a third insert 106 having a head 130 configured for polishing, etc. The workpiece 1 can be first cut via the first insert 106. After cutting the workpiece 1 with the first insert 106, the first insert 106 can be removed from the body 102. The second insert 106 can be secured to the body 102. The workpiece 1 can then be de-burred via the second insert 106. After de-burring the workpiece 1 with the second insert 106, the second insert 106 can be removed from the body 102. The third insert 106 can be secured to the body 102. The workpiece 1 can then be polished via the third insert 106.

Referring to FIG. 4B, as another example, a first insert 106 can be configured for cutting the workpiece 1, the first insert 106 including a shaft of length Y. A second insert 106 can be configured for cutting the workpiece 1, the second insert 106 including a shaft of length Z. The length of Z may be longer than the length of Y. Thus, the head 130 of the second insert 106, when secured to the connector 104, may extend radially inward from the inner surface 122a more than that of the head 130 of the first insert 106. An exemplary use of such first and second inserts 106 can be for performing a stepped turning process. For example, the first insert 106 may be used to generate a first region 5a of reduced cross sectional diameter, where a length of the first region 5a can correspond to a distance from the first insert 106 to the stop 118 and/or pin 124. The second insert 106 may be used to generate a second region 5b of reduced cross sectional diameter, where a distance of the second region 5b can correspond to a distance from the second insert 106 to the stop 118 and/or pin 124. The distance from the first insert 106 to the stop 118 may be greater than the distance from the second insert 106 to the stop 118 and/or pin 124.

For example, the first insert 106 (having shaft 128 length Y) can be secured to a first connector 104. The tool 100 can be used for turning, as described herein, to generate the first region 5a of reduced cross sectional diameter at or near the distal end 2 of the workpiece 1, the reduction of cross sectional diameter corresponding to the shaft length of Y. The first insert 106 can be removed from the first connector 104. The second insert 106 (having shaft 128 length of Z) can be secured to a second connector 104. The second connector 104 can be located on the body at a distance from the stop 118 and/or pin 124 that is less than the distance from the stop 118 and/or pin 124 the first connector 104 is located. The tool 100 can again be used for turning, as described herein, to generate a region 5b of reduced cross sectional diameter at or near the distal end 2 of the workpiece 1, the reduction of cross sectional diameter corresponding to the shaft length of Z. Thus, the workpiece 1 can be worked to have two regions 5a, 5b of reduced cross sectional diameter.

As another example, the first insert 106 (having shaft 128 length Y) can be secured to a connector 104. The tool 100 can be used for turning, as described herein, to generate a region 5 of reduced cross sectional diameter at or near the distal end 2 of the workpiece 1, the reduction of cross sectional diameter corresponding to the shaft length of Y. The first insert 106 can be removed from the connector 104. The second insert 106 (having shaft 128 length of Z) can be secured to the same connector 104. The tool 100 can again be used for turning, as described herein, to generate a reduced cross sectional diameter at or near the distal end 2 of the workpiece 1 within the same region 5, the reduction of cross sectional diameter corresponding to the shaft length of Z. Thus, the workpiece 1 can be worked to have a single region of reduced cross sectional diameter, but the reduction in diameter can occur in stages.

As another example, the first insert 106 can be secured to the first connector 104 and the second insert 106 can be secured to the second connector 104 to perform turning. The workpiece 1 can be inserted into the mouth 108 of the body 102 until the distal end 2 makes contact with the second insert 106. The tool 100 and/or workpiece 1 can be caused to rotate. The workpiece 1 and/or tool 100 can be caused to move along the longitudinal axis 114. This can include causing the workpiece 1 to move in the rearward direction 132 and/or causing the tool 100 to move in the forward direction 134, thereby generating the first region 5a of reduced cross sectional diameter on the workpiece 1. The workpiece 1 can be further moved in the rearward direction 132 and/or the tool 100 can be further moved in the forward direction 134 until the distal end 2 of the workpiece 1 makes contact with the first connector 104. At this point, the first region 5a may be partially formed. The workpiece 1 can be further moved in the rearward direction 132 and/or the tool 100 can be further moved in the forward direction 134, thereby generating the second region 5b of reduced cross sectional diameter on the workpiece 1 by the second insert 106 as the first insert continues to generate the first region 5a. Thus, the workpiece 1 can be worked to have two regions of reduced cross sectional diameter without having to interchange any inserts 106.

Other implementations and permutations of performing work and/or interchanging inserts 106 can be done to achieve a desired type of work on the workpiece 1. For example, some embodiments can be used to generate more than two regions of reduced cross sectional diameter. This can be achieved by using more than two inserts 106 of different shaft lengths. Some embodiments can include performing multiple types of work. This can be achieved by interchanging inserts 106 to perform the type of work. As noted above, some implementations can allow for simultaneous working without having to interchange inserts 106. This can be achieved by using the tool 100 with a first insert 106 in a first connector 104 and a second insert in a second connector 104, where the first insert 106 and the second insert 106 perform work on the workpiece 1 as the tool 100 and/or workpiece 1 is caused to rotate and/or move along the longitudinal axis 114.

Some embodiments can include more than two inserts 106. Any first insert 106 may be the same as or different from a second insert 106. Any second insert 106 can be the same as or different from a third insert 106 or the first insert 106. Any third insert 106 can be the same as or different from a fourth insert 106, the second insert 106, or the first insert 106. And so on. The first insert 106 may be configured to perform the same or different type of work as the second insert 106, the third insert 106, the fourth insert 106, etc. The first insert 106 may be located at a same or different radial location along the inner surface 122a and/or the same or different distance along the longitudinal axis 114 as that of the second insert 106, the third insert 106, the fourth insert 106, etc.

Referring to FIG. 5, in some embodiments, the body 102 can include a port 136. The port 136 may be an aperture formed into a portion of the sidewall 116. The aperture can extend from an outer surface 122b of the sidewall 116 to an inner surface 122a of the sidewall 116. The port 136 may be an opening within the sidewall 116 where the chamber 133 is located. The port 136 can facilitate ingress and/or egress to/from the chamber 133 portion. The port 136 may allow for interchangeability of inserts 106. For example, an insert 106 can be introduced through the port 136 to be secured to the connector 104. An insert 106 may also be removed from the connector 104 and extracted from the port 136. At least one edge of the port 136 may include an inlet 140. The inlet 140 may provide an access point to a connector 104 and/or an insert 106. For instance, an instrument may be used to assist with securing and/or removing an insert 106 to a connector 104 by introducing the instrument into the inlet 140.

The port 136 may further allow for discharge of work by-product. For example, as work is being performed on the workpiece 1, work by-product, such as swarf, chips, turnings, filings, shavings, etc.) can be generated. The work by-product may be collected within the chamber 133. The work by-product may be extracted through the port 136. This may be done to allow for the escape of the work by-product (e.g., drilling chips) so that they do not bind and/or damage the workpiece 1 or a surface of the workpiece 1. Discharging the work by-product can be achieved by reaching into the port 136 and pulling the work by-product out from the chamber 133. This can also be achieved by using forced air (e.g., forced air form a compressed air source) to blow out the work by-product. This can also be achieved by positioning the tool 100 so that the work by-product falls from the port 136. In some embodiments, the work by-product can be expelled from the chamber 133 via the port 136 automatically. This can be achieved by the centrifugal force acting on the work by-product as the tool 100 is caused to rotate, where the centrifugal force may cause the work by-product to be expelled from the port 136.

Some embodiments, at least one through-hole 142 can be provided. The through-hole 142 can extend from the outer surface 122b of the sidewall 116 to an inner surface 122a of the sidewall 116. The through-hole 142 may lead to a portion of the chamber 133 where the port 136 is located. The through-hole 142 can facilitate holding the insert 106 in place. For example, the through-hole 142 may be threaded to receive a threaded bolt. The threaded bolt may be inserted into the through-hole 142 and advanced radially inward toward an insert 106 that has been placed in the connector 104. The threaded bolt may be advanced until it makes contact with the insert 106. This may include holding the insert 106 in position.

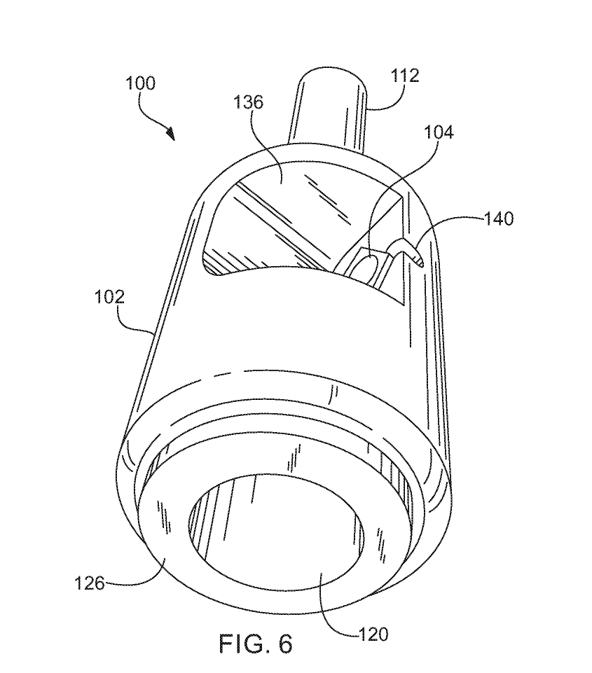

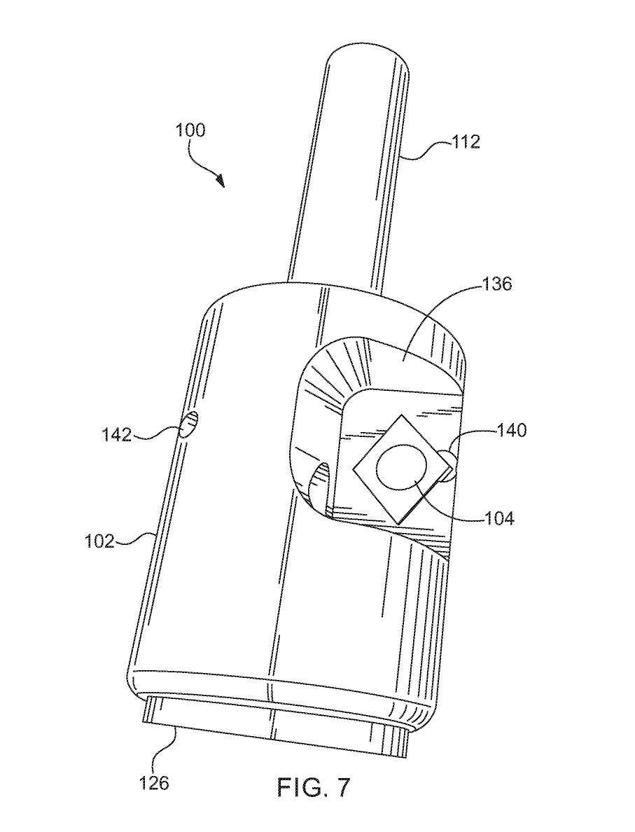

Referring to FIGS. 6-7, as noted above, some embodiments can include a buffer ring 126 located at or near the mouth 108 of the body 102. In some embodiments, the buffer ring 126 can be configured to not extend into the chamber 133 portion where the port 136 is located. In other words, the buffer ring 126 may extend from a portion at or near the mouth 108 to a portion of the chamber 133 so that no portion of the buffer ring 126 extends into a portion of the chamber 133 where the port 136 is formed into the sidewall 116.

In some embodiments, the buffer ring 126 can extend beyond the mouth 108. This may be done to provide a protective barrier between the first end 110 of the body 102 and a portion of the workpiece 1. For example, the workpiece 1 may be part of another object. The tool 100 can be used to perform work on the workpiece 1 while the buffer ring 126 portion that extends beyond the mouth 108 can prevent the tool 100 from making physical contact with the object to which the workpiece 1 is attached. For example, the buffer ring 126 can make contact with the object of the workpiece 1 so that it prevents the first end 110 from making contact with the object. As noted above, the buffer ring 126 may be made of material that is softer than that of the workpiece 1. This can include being softer than the object to which the workpiece 1 is attached.

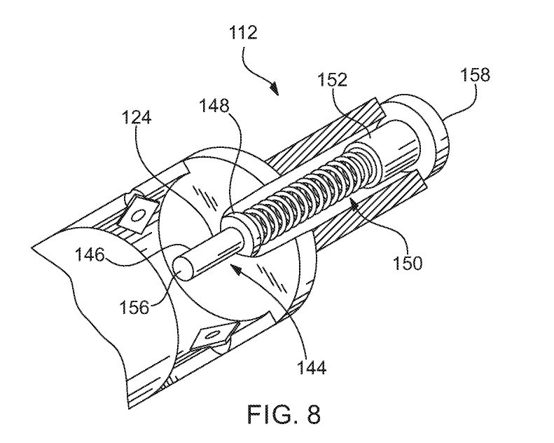

Referring to FIG. 8, in some embodiments, the stop 118 can include a pin aperture 144. The pin aperture 144 can be configured to slidably receive a pin 124. The pin 124 can include a pin distal end 146 and a pin head 148. At least a portion of the second end 112 can also slidably receive the pin 124. For example, the second end 112 may be a shank having a bore 150 forming therein. The bore 150 can be along the longitudinal axis 114. The bore 150 can be configured to slidably engage with the pin head 130. The pin aperture 144 can have a diameter that is less than that of the bore 150. The pin aperture 144 may have a diameter that is slightly larger than that of the pin 144. The pin head 130 can have a diameter that is greater than the pin 124. The bore can have a diameter that is slightly larger than that of the pin head 148. The step generated by the difference in diameters between the bore 150 and the pin aperture 144 can generate a mechanical stop for the pin 124. For example, the pin 124 may be able to slide along the longitudinal axis 114 and be bound by the distal end 152 of the shank and the mechanical stop. For example, the pin head 148 may be caused to abut against the mechanical stop, ceasing the pin's 144 movement in the forward direction 134. The pin head 148 may be caused to abut against the shank distal end 152, ceasing the pin's movement in the rearward direction 132.

The length of the pin 124 can be such that, as the pin 124 traverses a path along the longitudinal axis 114, the pin distal end 146 can protrude into and/or be retracted from the chamber. For example, when the pin head 130 abuts the mechanical stop, the pin distal end 146 may protrude into the chamber 133. When the pin 124 is moved in the rearward direction 132, the pin distal end 146 can be caused to move out from the chamber 133 and into the pin aperture 144.

In some embodiments, a spring 154 can be placed within the bore 150. This can include positioning the spring 154 between the distal end 152 of the shank and the pin head 148. This can be done to bias the pin 124 in the forward direction 134. This can further include biasing the pin 124 in the forward direction 134 so that the pin distal end 146 protrudes into the chamber 133. This can further include biasing the pin 124 in the forward direction 134 so that the pin distal end 146 protrudes into the chamber 133 unless the pin 124 is acted upon so as to cause the pin 124 to move in the rearward direction 132. In some embodiments, the spring 154 can be configured to prevent the pin distal end 146 from being retracted into the pin aperture 144 but still allow movement of the pin 124 in the rearward direction 132. This can include allowing the pin 124 to be moved in the rearward direction 132 until the pin distal end 2 is flush or approximately flush with the stop 118. This may be done to prevent the distal end 2 of the workpiece 1 from making contact with the stop 118.

In some embodiments, the pin 124 can freely rotate within the pin aperture 144. This may be done to allow the distal end 2 of the workpiece 1 to abut against a non-rotating member as the tool 100 and/or workpiece 1 is caused to rotate. This may prevent unwanted work and/or damage being done to the distal end 2 of the workpiece 1. For example, as the tool 100 and/or workpiece 1 is rotated to perform work on the workpiece 1, the workpiece 1 and/or tool 100 may be caused (intentionally or inadvertently) to move relative to each other along the longitudinal axis 114. The distal end 2 of the workpiece 1 may abut against the pin distal end 146 as opposed to abutting against the stop 118. In some embodiments, the pin 124 and the workpiece 1 may remain stationary (with respect to rotational motion) while the tool 100 is caused to rotate. In some embodiments, the pin 124 may be caused to rotate with the workpiece 1 as the workpiece 1 is caused to rotate. The spring 154 can allow the pin distal end 146 to move forward 134 and/or rearward 132 so as to facilitate a desired type of work. For example, allowing the pin 124 to move forward 134 and/or rearward 132 can allow the workpiece 1 to be moved relative to the tool 100 along the longitudinal axis 114. As noted above, in some embodiments, the spring 154 may be configured to prevent the pin distal end 146 from being retracted into the pin aperture 144. This may include allowing the pin distal end 146 to move rearward 132 until it is flush or approximately flush with the stop 118. This may allow the workpiece 1 to be moved up to the stop 118 without making physical contact with the stop 118.

In some embodiments, the pin distal end 146 can include a pad 156. The pad 156 can include a material that is softer than that of the workpiece 1. This can be done to provide protection to the workpiece 1 when the workpiece makes contact with the pad 156.

In some embodiments, the pin 124 and/or the spring 154 can be secured within the bore 150 via a cap 158. For example, the cap 158 can be configured to removably secure to the distal end 152 of the shank. This can be achieved by the cap 158 being threaded so that it can threadingly engage with threading of the bore 150. This may be done to facilitate interchangeability and/or replacement of the pin 124 and/or spring 154.

While exemplary embodiments may describe the tool 100 being rotated via a rotatable drive 200, other implementations can be used. For example, the workpiece 1 can also be caused to rotate via a rotatable drive 200. This can include causing the workpiece 1 to rotate while holding the tool 100 stationary. For example, the second end 112 of the tool 100 can be secured so as to remain stationary. The workpiece 1 can be inserted into the tool 100 via the mouth 108. The workpiece 1 can then be caused to rotate via the rotatable drive 200. In some embodiments, the workpiece 1 and the tool 100 can be caused to rotate with separate rotatable drives 200. This can include causing the workpiece 1 to rotate in one direction while causing the tool 100 to rotate in another direction. This can further include causing the workpiece 1 to rotate in a same direction as the tool 100 but at a different rotational speed. Rotation of the tool 100 and/or the workpiece 1 can be along the longitudinal axis 114.

It should be understood that modifications to the embodiments disclosed herein can be made to meet a particular set of design criteria. For instance, the number of tools 100, bodies 102, connectors 104, inserts 106, pins 124, pin apertures 144, through-holes 142, buffer rings 126, ports 136, inlets 140, bores 150, springs 154, pads 156, caps 158, and other components can be any suitable number of each to meet a particular objective. The particular configuration of such elements can also be adjusted to meet a particular set of design criteria. Therefore, while certain exemplary embodiments of devices and methods of making and using the same have been discussed and illustrated herein, it is to be distinctly understood that the invention is not limited thereto but may be otherwise variously embodied and practiced within the scope of the following claims.

What is claimed is:

1. A tool, comprising:
a body comprising an elongated member having a first end, a second end, an open workpiece chamber located between the first end and the second end, the open workpiece chamber having a chamber wall and a workpiece aperture extending from the first end to the open chamber, the workpiece aperture being sized to receive a workpiece; and,
at least one insert attached to the chamber wall and positioned to engage the workpiece that is within the open workpiece chamber.

2. The tool recited in claim 1, wherein the second end and the first end are aligned along a longitudinal axis and at least one of the workpiece and the tool is rotatable about the longitudinal axis.

3. The tool recited in claim 1, wherein the tool and the workpiece are translatable relative to each other along the longitudinal axis.

4. The tool recited in claim 2, wherein rotation of at least one of the workpiece and the tool is caused by a rotatable drive.

5. The tool recited in claim 4, further comprising a cutting system, the cutting system comprising the tool and rotatable drive.

6. The tool recited in claim 1, wherein the at least one insert is configured to at least one of cut, turn, chamfer, de-burr, groove, knurl, grind, buff, burnish, and polish the workpiece.

7. The tool recited in claim 1, wherein the first end comprises a mouth into which a buffer ring is disposed.

8. The tool recited in claim 3, wherein the at least one insert configured to perform work on the workpiece while the tool and the workpiece are translated relative to each other along the longitudinal axis.

9. The tool recited in claim 1, wherein the at least one insert is configured to make contact with an outer surface of the workpiece so as to prevent the outer surface of the workpiece from making contact with the chamber wall.

10. The tool recited in claim 9, wherein the first end comprises a mouth into which a buffer ring is disposed; and, the buffer ring is configured to make contact with a portion of the outer surface of the workpiece to hold the workpiece approximately parallel to a longitudinal axis of the tool.

11. The tool recited in claim 1, wherein a port is formed into a sidewall of the body to generate the open workpiece chamber.

12. The tool recited in claim 11, wherein the port is configured to facilitate discharge of work by-product.

13. The tool recited in claim 12, wherein the tool is configured to automatically discharge the work by-product.

14. The tool recited in claim 11, wherein the body further comprises at least one through-hole.

15. The tool recited in claim 2, wherein:
the body further comprises sidewalls conjoined with a stop;
the second end further comprises a pin configured to move along the longitudinal axis and configured to prevent a distal end of the workpiece from making contact with the stop.

16. The tool recited in claim 15, wherein the pin is freely rotatable about the longitudinal axis.

17. The tool recited in claim 15, further comprising a spring configured to bias the pin in a direction along the longitudinal axis.

18. A tool, comprising:
a body comprising an elongated member with a workpiece aperture formed therein, the body having a first end and a second end, the second end configured to be held by a securement means, the first end configured to receive at least a portion of a workpiece;
at least one connector located within the workpiece aperture; and,
at least one insert removably inserted into the at least one connector, the at least one insert configured to perform work on the workpiece while at least one of the workpiece and the tool is rotated,
wherein a port is formed into a portion of the body.

19. The tool recited in claim 18, further comprising a plurality of inserts, each insert of the plurality of inserts configured to perform a type of work that is different from a type of work of each other insert.

20. A method of performing work on a workpiece, the method comprising:
inserting an insert configured to perform work on a workpiece into a connector of a tool, the tool comprising a body having a first end and a second end, the first end having a workpiece aperture and a port leading to a chamber, the connector formed within the chamber, the workpiece aperture being aligned along a longitudinal axis of the tool;
inserting a portion of a workpiece into the workpiece aperture so as to cause the insert to make contact with a surface of the workpiece; and,
causing at least one of the workpiece and the tool to at least one of rotate about the longitudinal axis and move along the longitudinal axis to facilitate performing the work on the workpiece.
